(19) United States
(12) Patent Application Publication
(10) Pub. No.: US 2008/0112304 A1
(43) Pub. Date: May 15, 2008

(54) Spot Alignment For Parrallel Read-Out Of Two-Dimensional Encoded Optical Storage Media

(75) Inventors: Alexander Marc Van Der Lee, Eindhoven (NL); Christopher Busch, Eindhoven (NL); Dominique Maria Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,116

(22) PCT Filed: Apr. 14, 2005
(86) PCT No.: PCT/IB05/51223

§ 371 Date: Oct. 20, 2006

(30) Foreign Application Priority Data
Apr. 21, 2004 (EP) 04101640.3

(51) Int. Cl. G11B 7/00; G11B 7/24

(52) U.S. Cl. 369/124.03; 369/275.3

(57) ABSTRACT

The present invention provides a two-dimensional encoded optical storage medium (12) comprising at least one alignment pattern (14) for aligning a spot array (16) intended to read out the optical storage medium (12). Furthermore, the present invention is directed to a method and a device for reading out a two-dimensional encoded optical storage medium (12) having at least one alignment pattern (14) comprising a plurality of bit rows (R1, R2, R3, R4, R5, R6, R7, R8), wherein at least one bit row (R2, R3, R4, R6, R7, R8) of said alignment pattern (14) is empty.

### FIELD OF THE INVENTION

The present invention relates to a two-dimensional encoded optical storage medium. Furthermore, the present invention relates to a method for aligning a spot array of a device suitable for reading out a two-dimensional encoded optical storage medium and to a device for reading out a two-dimensional encoded optical storage medium.

### BACKGROUND OF THE INVENTION

FIG. 1 shows a conventional possibility of optical data storage. The data is written in the form of pits along a track T. The pitch between the tracks T is chosen such that the radial error signal is large enough to do tracking (via three spots push-pull/CA, or DPD, etc.) and to have a tolerable level of inter-track cross talk (for the reading as well as the writing process).

FIG. 2 shows a section of a two-dimensional encoded disk where a higher density of data is achieved by minimizing the track separation of the data. Thereby in effect several (can be many) tracks are combined into one meta-track 18 consisting of closely spaced bit rows, which is confined by a so called guard band G. By doing this, the information density becomes more isotropic in tangential and radial (track) direction. This means that conventional single spot tracking mechanisms no longer produce enough modulation to do radial tracking.

For parallel read-out of the two-dimensional encoded disk, a spot array needs to be aligned on the corresponding array of bit rows. As the separation between the bit rows is much smaller than between the spots arranged in a line, the spot array has to be set at an angle in such a way that every spot of the array is aligned with its corresponding bit row, as shown in FIG. 2. An alignment of the spot array particularly may be necessary due to variations between disks or maybe even within a disk.

It is the object of the present invention to provide a possibility to achieve this correct alignment of the spots of the spot array and the bit rows of the meta-track, even if the track pitch of the bit rows is smaller than lambda/2NA.

### SUMMARY OF THE INVENTION

The above object is solved by the features of the independent claims. Further developments and preferred embodiments of the invention are outlined in the dependent claims.

In accordance with a first aspect of the present invention, there is provided a two-dimensional encoded optical storage medium comprising at least one alignment pattern for aligning a spot array intended to read out the optical storage medium. The alignment pattern makes it possible to adjust the angle between the spot array and the meta-track and/or the distance between the single spots of the spot array such that each spot of the spot array is aligned with one bit row of the meta-track.

With preferred embodiments of the invention said alignment pattern comprises a plurality of bit rows forming a meta-track, wherein at least one bit row of said alignment pattern is empty. For example the alignment pattern may comprise a written bit row followed by three empty bit rows. By such a spacing of the written bit rows of the alignment pattern the spot array spots that fall on written bit rows provide radial information.

Preferably, at least one written bit row of said alignment pattern comprises a periodical pit pattern. For example one written bit row of the alignment pattern may contain a pattern with a bit sequence of five pits, followed by five land. Next to this written bit row, three empty bit rows may for example be present, followed by a second written bit row consisting of eight pits, followed by eight land. Also this second bit row may be followed by three empty bit rows. Such a basis block may then be repeated.

With preferred embodiments of the invention at least one alignment pattern is placed in a lead in. Such an alignment pattern in the lead in may be used to do an initial alignment of the spot array.

It may also be advantageous that at least one alignment pattern is placed between data sections. Thereby, the spots of the spot array can be adjusted to follow a varying track pitch of the bit rows. The density of the alignment patterns between the data sections in most cases can be low since in most cases the expected variation of the track pitch is small.

In accordance with a second aspect of the present invention there is provided a method for aligning a spot array of a device suitable for reading out a two-dimensional encoded optical storage medium having at least one alignment pattern comprising a plurality of bit rows, wherein at least one bit row of said alignment pattern is empty, said method comprising the following steps: a) evaluating signals obtained via at least two spots of said spot array that fall on written bit rows of said alignment pattern to obtain radial information; and b) aligning, if necessary, said spot array in response to said radial information. Also with this method it is possible to adjust the angle between the spot array and the meta-track and/or the distance between the single spots of the spot array such that each spot of the spot array is aligned with one bit row of the meta-track. The optical storage medium in accordance with the invention may advantageously be used in connection with all embodiments of the method in accordance with the invention.

For the method in accordance with the present invention it is preferred, that said step a) comprises evaluating a phase difference between said signals. When the spots of the spot array are correctly aligned, the sinusoidal signals have the same phase. In the case of a misalignment, a clear phase difference is seen.

In this context it is preferred that at least one signal of said signals is a low frequency filtered signal. Preferably, two low frequency filtered CA signals are used.

With preferred embodiments said step b) comprises varying an angle of said spot array relative to said plurality of bit rows. This may for example be achieved by rotating a grating used for creating the spot array.

Alternatively or additionally said step b) comprises varying a distance between spots of said spot array. The distance between the single spots may for example be adjusted by varying the distance between a grating used for creating the spot array and a collimator arranged adjacent to the grating.

In accordance with a third aspect of the present invention there is provided a device for reading out a two-dimensional encoded optical storage medium having at least one alignment pattern comprising a plurality of bit rows, wherein at least one bit row of said alignment pattern is empty, comprising: means for generating a spot array; and means for aligning said spot array relative to said plurality of bit rows in response to radial information obtained via at least two spots of said spot array that fall on written bit rows of said alignment pattern. Compared to a conventional light path, the means for generating the spot array particularly may comprise an additional grating, for example arranged adjacent to the laser. Also with the device in accordance with the present invention a correct alignment of the spots of the spot array and the bit rows of the meta-track is achieved, even if the track pitch of the bit rows is smaller than lambda/2NA.

With preferred embodiments of the device, it comprises means for evaluating a phase difference between signals obtained via said at least two spots of said spot array that fall on written bit rows of said alignment pattern. The means for evaluating the phase difference may be formed by analogue and/or digital circuitry. Particularly, these means may include hardware interacting with appropriate software.

Preferably, at least one signal of said signals is a low frequency filtered signal. The signals particularly may be at least two low frequency filtered CA signals.

Preferably, said means for aligning said spot array comprise means for varying an angle of said spot array relative to said plurality of bit rows.

In this context it is preferred that said means for varying said angle of said spot array comprise means for rotating a grating, wherein said grating is arranged in an optical path of a laser beam. The means for rotating the grating may be formed by any suitable actuator known in the art.

Alternatively or additionally, said means for aligning said spot array comprise means for varying a distance between spots of said spot array.

Preferably, said means for varying said distance vary the position of a grating arranged in an optical path of a laser beam. It is clear to the person skilled in the art that for example also the grating constant and/or other design parameters of the optical light path may varied to achieve the proper alignment of the spot array.

These and other aspects of the invention will be apparent from and elucidated with reference to the embodiments described hereinafter.

### BRIEF DESCRIPTION OF THE DRAWINGS

FIG. 1 shows an example of a layout of data on a conventional one-dimensional encoded disk;

FIG. 2 shows a meta-track of a two-dimensional encoded disk;

FIG. 3 is a schematic diagram illustrating one embodiment of the device in accordance with the invention, wherein this device is also suitable to carry out the method in accordance with the invention;

FIG. 4 shows an example of an alignment pattern;

FIG. 5 shows examples of spots properly aligned with bit rows;

FIG. 6 shows examples of spots not properly aligned with bit rows;

FIG. 7 is a scope trace showing two low frequency filtered CA aperture signals in case of a spot array which is properly aligned; and

FIG. 8 is a scope trace showing two low frequency filtered CA aperture signals in case of a spot array which is not properly aligned;

### DESCRIPTION OF PREFERRED EMBODIMENTS

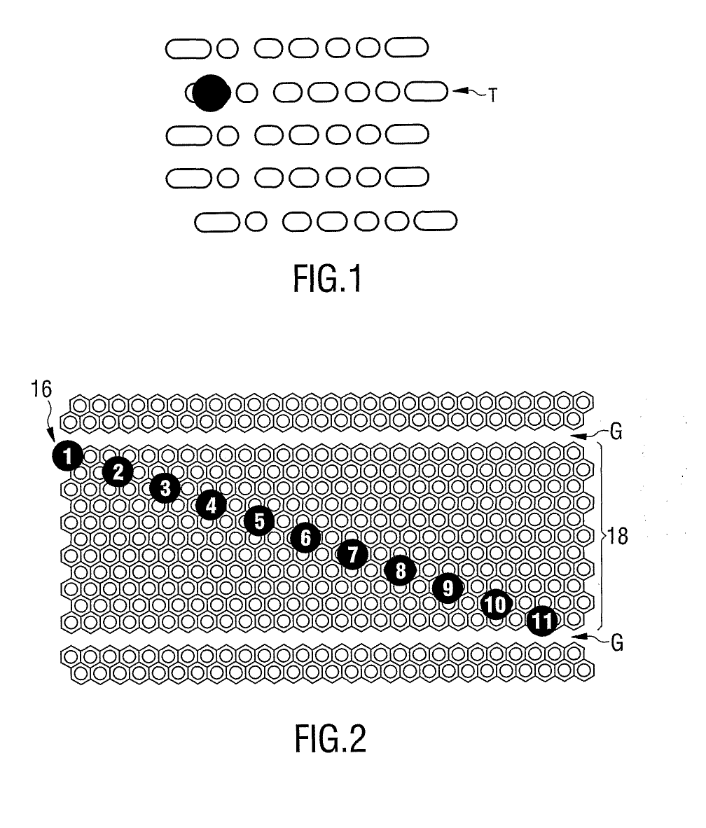

As already mentioned in the beginning, FIGS. 1 and 2 show the difference between the conventional layout of the data on a conventional one-dimensional encoded disk (FIG. 1) and the layout on a two-dimensional encoded disk (FIG. 2). On a one-dimensional encoded disk the data is located along a track T. On a two-dimensional encoded disk the data is contained in a broad meta-track 18, which consists of several bit rows (eleven bit rows in the example shown). The broad meta-track 18 is enclosed by a guard band G (space containing no data). This guard band G can be used for obtaining error signals for aligning the spot array with the meta-track 18. While in FIG. 1 there is shown a single spot aligned with the track T, in FIG. 2 there is shown a spot array 16. The spot array 16 consists of 11 spots 1 to 11 which are arranged in a line and are spaced equidistantly.

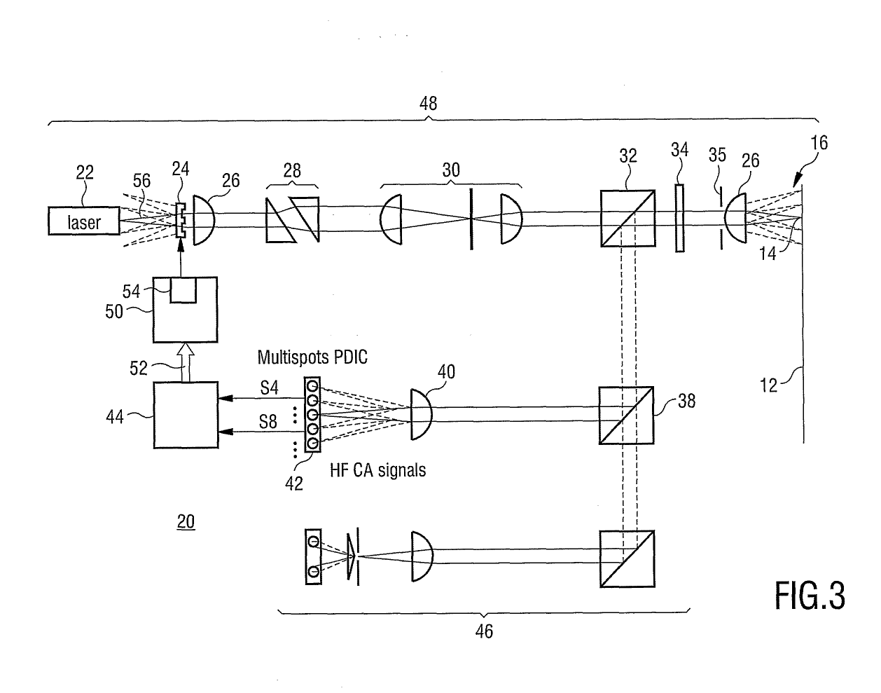

FIG. 3 is a schematic diagram illustrating one embodiment of a device 20 for reading out a two-dimensional encoded optical storage medium 12. With this embodiment the optical storage medium is a disk 12 comprising at least one alignment pattern 14, as will be described in more detail later. The device 20 comprises means 48 for generating a spot array 16 on the disk 12.

These means 48 comprise a laser 22 which generates a laser beam 56. The first element in the optical path is a grating 24 which separates the laser beam 56 in several beams that finally form the spot array 16. Behind the grating 24 there is located a collimator 26 which is followed by a beamshaper 28 and a telescope 30. Behind the telescope 30 there is arranged a first polarizing beamsplitter 32 which in the horizontal direction is followed by a λ/4-element 34, an aperture 35 and an objective lens 36.

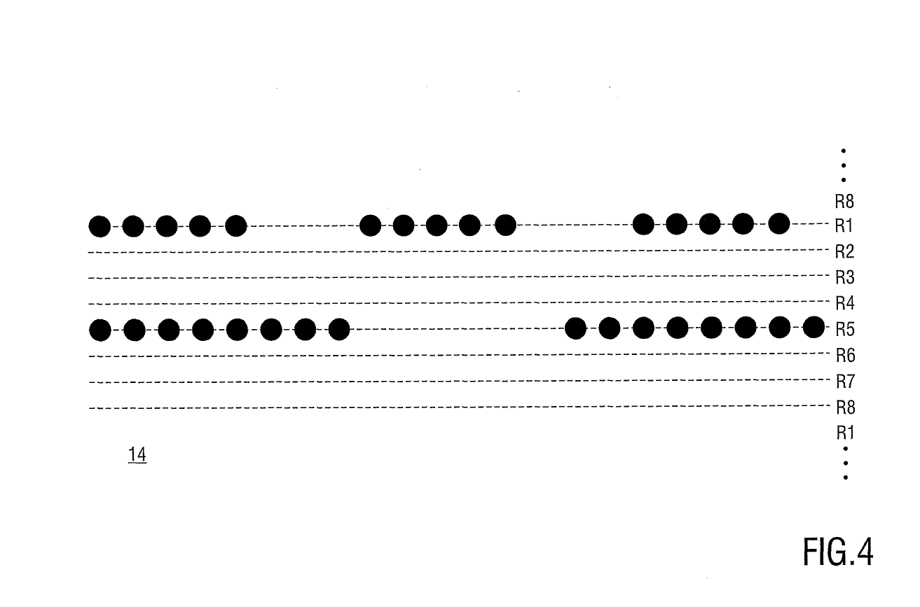

Light reflected from the disk 12 reaches a second beamsplitter 38 via the first beamsplitter 32. One part of the light reaching the second beamsplitter 38 is forwarded to means 46 that are not of further interest in the present context, but are required for performing a Foucault wedge method for a focus error signal. The other part of the light reaching the second beamsplitter 38 is directed to a photo detector IC 42 via a lens 40. The photo detector IC 42 provides an electrical signal for every spot of the spot array, wherein in FIG. 3 there are only shown signals S4 and S8 representing the information contained in bit rows R1 and R5, as will be explained later in more detail with reference to FIG. 4.

The general signal processing for reading out data form the disk 12 is known to the person skilled in the art and is not subject of the present invention. Therefore, only the signal processing necessary for performing the alignment of the spot array in accordance with the invention will be described here.

Referring back to FIG. 3, it is assumed that the signals S4 and S8 are low frequency filtered signals S4, S8. The respective filter means are not explicitly shown and may for example be assigned to the photo detector IC 42 or may be formed separately. The low frequency filtered signals S4 and S8 are forwarded to means 44 for evaluating a phase difference, if any, between the signals S4 and S8. Such a phase difference contains radial information 52 with respect to the present alignment of the spot array 16. In case that there is no phase difference, the spot array 16 is correctly aligned with respect to the meta-track, as will be explained in more detail below. If there is phase difference between the signals S4 and S8, then the radial information 52 obtained via this phase difference is used by means 50 for aligning the spot array 16 correctly. To achieve this, the means 50 comprise means 54 in form of one or more actuators that are capable to rotate and/or move the grating 24. By rotating the grating 24 the angle between the spot array 16 and the meta-track on the disk 12 may be varied to properly align the spot array 16. By moving the grating closer to or further away from the collimator 26, the distance between the single spots of the spot array 16 may be varied to properly align the spot array 16. It is clear for the person skilled in the art that also the grating constant influences the separation of the single spots of the spot array 16.

FIG. 3 not only illustrates an embodiment of the device in accordance with the invention but also a possibility to carry out the method in accordance with the invention. However, it is to be understood, that the device illustrated in FIG. 3 is only one possible embodiment of the invention and that the person skilled in the art may perform several modifications depending on the actual needs. For example the laser 22 and the grating 14 could be replaced by a laser array. The beamshaper 28 may be arranged at any other suitable position of the light path. In practical embodiments the telescope 30 may be omitted. For detecting the focus error also other known methods than Foucault detection may be used. Furthermore, in case of large displacements of the spots means for realigning the detector may be provided.

FIG. 4 shows an example of a suitable alignment pattern 14. The alignment pattern 14 in bit row R1 contains a pattern with a bit sequence of five pits, followed by five land, which is repeated periodically. Next to this bit row R1, three empty bit rows R2, R3, R4 are present, followed by a bit row R5 consisting of eight pits, followed by eight land. Also this bit sequence is repeated periodically. The bit row R5 again is followed by three empty bit rows R6, R7, R8. This basis block is then repeated. It should be understood that it is highly preferred for the invention that the periodic patterns in the written bit rows R1, R5 have very different periods. Therefore, it should be clear that the five and eight pits mentioned above are also one possible non-restricting example. Furthermore, it should be understood that the basis block may comprise any suitable number of bit rows, i.e. more or less than the eight bit rows R1 to R8 shown in the drawings and mentioned herein.

The alignment pattern 14 can be placed in the lead in of the disk 12, in order to perform an initial alignment of the spot array 16. Additionally, alignment patterns 14 can be placed in the data such that the spots can be adjusted to follow a varying track pitch of the bit rows. In most cases the density of these alignment patterns 14 placed in the data of the disk 12 can be low since the expected variation of track pitch is small.

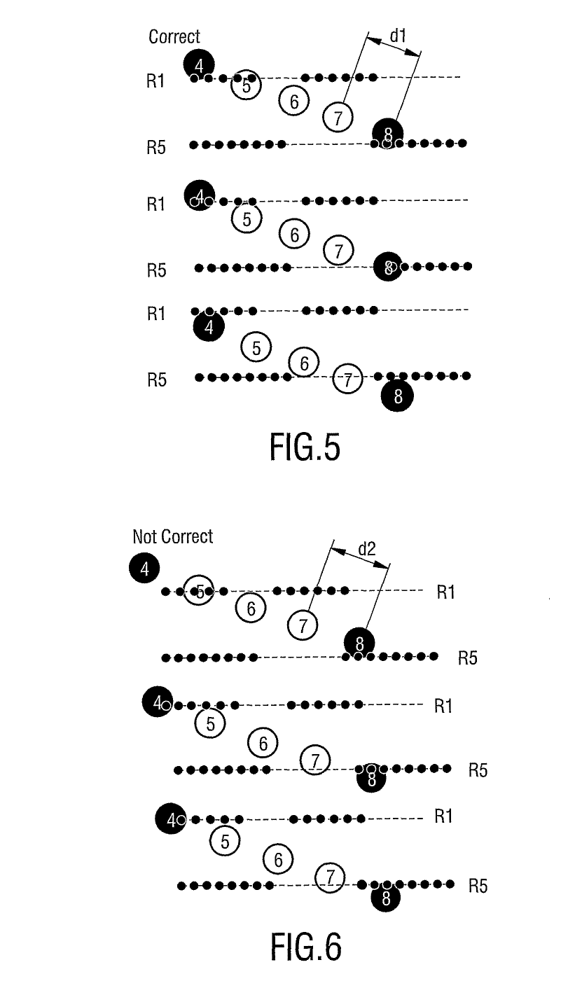

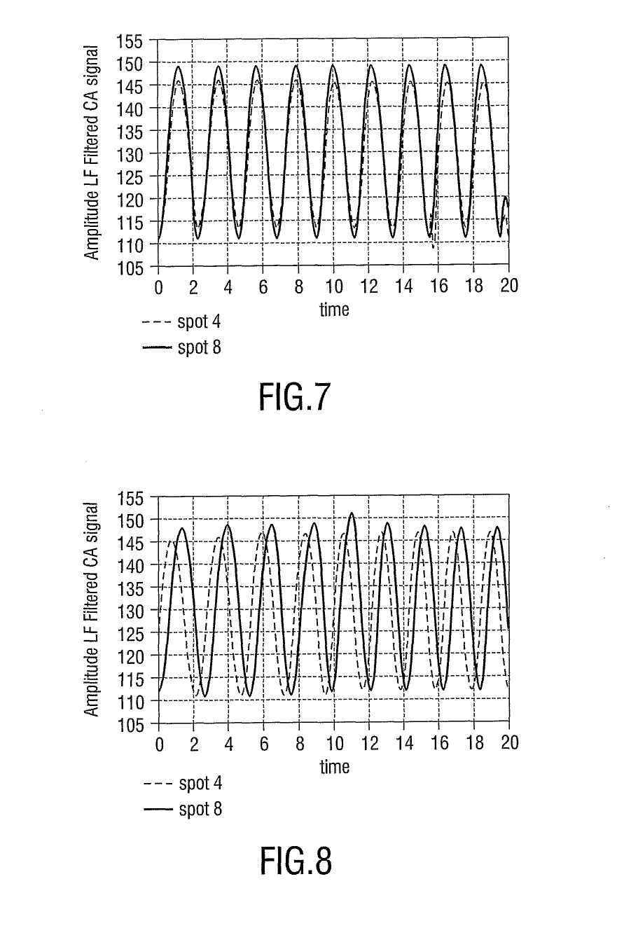

When the disk 12 rotates, the read out spots 1 to 11 move over the bit rows Rᵢ in radial (and also tangential) direction due to eccentricity of the disk 12 (or by a forced translation of the sledge). By acquiring the low frequency filtered CA signals S4, S8 of the spots that are separated by three empty bit rows, the alignment of the spots 1 to 11 with respect to the bit rows Rᵢ can be monitored. This is sketched in FIGS. 5 to 8, wherein FIG. 5 shows examples of spots 1 to 11 properly aligned with the bit rows Rᵢ, FIG. 6 shows examples of spots 1 to 11 not properly aligned with bit rows Rᵢ, FIG. 7 is a scope trace showing two low frequency filtered CA aperture signals S4, S8 in case of a spot array 16 which is properly aligned, and FIG. 8 is a scope trace showing two low frequency filtered CA aperture signals S4, S8 in case of a spot array 16 which is not properly aligned. The phase difference in the signals S4 and S8 of spot 4 and spot 8 is an indicator for the alignment error. The phase error has to be reduced to zero for the correct spot alignment with respect to the bit rows Rᵢ. By changing the orientation of the spot array 16 (by rotating the grating 24) or, as shown in FIGS. 5 and 6, by changing the distance between the spots 1 to 11 (by e.g. changing the distance between the grating 24 and the laser 22) this can be achieved. Additionally, the HF signals of spot 4 and spot 8 need to contain a different carrier frequency (e.g. either the 5T or 8T) when CA modulation is maximal. When the carrier frequency is the same, the spots 1 to 11 are not on the appropriate bit row, but they are aligned on bit rows that are either located too high or too low within the meta-track 18. Additional information from the CA signal of the other spots 1 to 3 and 5 to 11 can be used to exclude wrong alignment.

Instead of using the central aperture signal also the push-pull signal can be used to obtain radial information. This is less convenient than the central aperture as one is sensitive for beam landing and a split detector; i.e. extra detector segments are needed in this case.

Furthermore, equivalents and modifications not described above may also be employed without departing from the scope of the invention, which is defined in the accompanying claims.

1. A two-dimensional encoded optical storage medium (12) comprising at least one alignment pattern (14) for aligning a spot array (16) intended to read out the optical storage medium (12).

2. The optical storage medium (12) according to claim 1, characterized in that said alignment pattern (14) comprises a plurality of bit rows (R1, R2, R3, R4, R5, R6, R7, R8) forming a meta-track (18), wherein at least one bit row (R2, R3, R4, R6, R7, R8) of said alignment pattern (14) is empty.

3. The optical storage medium (12) according to claim 2, characterized in that at least one written bit row (R1, R5) of said alignment pattern (14) comprises a periodical pit pattern.

4. The optical storage medium (12) according to claim 1, characterized in that at least one alignment pattern (14) is placed in a lead in.

5. The optical storage medium (12) according to claim 1, characterized in that at least one alignment pattern (14) is placed between data sections.

6. A method for aligning a spot array (16) of a device (20) suitable for reading out a two-dimensional encoded optical storage medium (12) having at least one alignment pattern (14) comprising a plurality of bit rows (R1, R2, R3, R4, R5, R6, R7, R8), wherein at least one bit row (R2, R3, R4, R6, R7, R8) of said alignment pattern (14) is empty, said method comprising the following steps:
a) evaluating signals (S4, S8) obtained via at least two spots (4, 8) of said spot array (16) that fall on written bit rows (R1, R5) of said alignment pattern (14) to obtain radial information (52); and
b) aligning, if necessary, said spot array (16) in response to said radial information.

7. The method according to claim 6, characterized in that said step a) comprises evaluating a phase difference between said signals (S4, S8).

8. The method in accordance with claim 6, characterized in that at least one signal (S4, S8) of said signals (S4, S8) is a low frequency filtered signal (S4, S8).

9. The method in accordance with claim 6, characterized in that said step b) comprises varying an angle of said spot array (16) relative to said plurality of bit rows (R1, R2, R3, R4, R5, R6, R7, R8).

10. The method according to claim 6, characterized in that said step b) comprises varying a distance (d1, d2) between spots (1, 2, 3, 4, 5, 6, 7, 8, 9, 10, 11) of said spot array (16).

11. A device (20) for reading out a two-dimensional encoded optical storage medium (12) having at least one alignment pattern (14) comprising a plurality of bit rows (R1, R2, R3, R4, R5, R6, R7, R8), wherein at least one bit row (R2, R3, R4, R6, R7, R8) of said alignment pattern (14) is empty, comprising:
means (48) for generating a spot array (16); and
means (50) for aligning said spot array (16) relative to said plurality of bit rows (R1, R2, R3, R4, R5, R6, R7, R8) in response to radial information (52) obtained via at least two spots (4, 8) of said spot array (16) that fall on written bit rows (R1, R5) of said alignment pattern (14).

12. The device (20) according to claim 11, characterized in that it comprises means (44) for evaluating a phase difference between signals (S4, S8) obtained via said at least two spots (4, 8) of said spot array (16) that fall on written bit rows (R1, R5) of said alignment pattern (14).

13. The device (20) according to claim 12, characterized in that at least one signal (S4, S8) of said signals (S4, S8) is a low frequency filtered signal (S4, S8).

14. The device (20) according to claim 11, characterized in that said means (50) for aligning said spot array (16) comprise means (54) for varying an angle of said spot array (16) relative to said plurality of bit rows (R1, R2, R3, R4, R5, R6, R7, R8).

15. The device (20) according to claim 14, characterized in that said means for varying said angle of said spot array comprise means (54) for rotating a grating (24), wherein said grating (24) is arranged in an optical path of a laser beam (56).

16. The device (20) according to claim 11, characterized in that said means (50) for aligning said spot array (16) comprise means (54) for varying a distance (d1, d2) between spots (1, 2, 3, 4, 5, 6, 7, 8, 9, 10, 11) of said spot array (16).

17. The device (20) according to claim 14, characterized in that said means (54) for varying said distance (d1, d2) vary the position of a grating (24) arranged in an optical path of a laser beam (56).
